(19) United States
(12) Patent Application Publication
(10) Pub. No.: US 2009/0034916 A1
(43) Pub. Date: Feb. 5, 2009

(54) FIBER OPTIC CABLE WITH IN-LINE FIBER OPTIC SPLICE

(76) Inventor: Thomas G. LeBlanc, Westminster, MA (US)

Correspondence Address: MERCHANT & GOULD PC, P.O. BOX 2903, MINNEAPOLIS, MN, 55402-0903, US

(21) Appl. No.: 12/170,779

(22) Filed: Jul. 10, 2008

Related U.S. Application Data
(60) Provisional application No. 60/948,792, filed on Jul. 10, 2007.

(51) Int. Cl. G02B 6/255

(52) U.S. Cl. 385/96; 65/407

(57) ABSTRACT

A fiber optic cable includes first and second fiber optic cables segments that are joined at an in-line splice location at which a fiber optic splice is located. The in-line splice location includes a strain transference arrangement configured to inhibit strain from being transferred to the fiber optic splice.

### CROSS REFERENCE

This application claims priority to U.S. Provisional Patent Application Ser. No. 60/948,792, filed on Jul. 10, 2007, the disclosure of which is hereby incorporated by reference herein.

### TECHNICAL FIELD

The present disclosure relates generally to a fiber optic data transmission system. More particularly, the present disclosure relates to splice configurations for use with fiber optic data transmission systems.

### BACKGROUND

Fiber optic cables are widely used to transmit light signals for high speed data transmission. A fiber optic cable typically includes: (1) an optical fiber or optical fibers; (2) a buffer or buffers that surrounds the fiber or fibers; (3) a strength layer that surrounds the buffer or buffers; and (4) an outer jacket. Optical fibers function to carry optical signals. A typical optical fiber includes an inner core surrounded by a cladding that is covered by a coating. Buffers (e.g., loose or tight buffer tubes) typically function to surround and protect coated optical fibers. Strength layers add mechanical strength to fiber optic cables to protect the internal optical fibers against stresses applied to the cables during installation and thereafter. Example strength layers include aramid yarn, steel, and epoxy reinforced glass roving. Outer jackets provide protection against damage caused by crushing, abrasions, and other physical damage. Outer jackets also provide protection against chemical damage (e.g., ozone, alkali, acids).

Fusion splices are often used in fiber optic communication systems to provide a fiber optic connection between two optical fibers. Typically, fiber optic splices are protected within splice sleeves. A typical splice sleeve includes a polymeric tube reinforced with a stainless steel reinforcing member. Splice sleeves containing splices are typically protected and managed in auxiliary structures such as splice trays, enclosures, or other types of splice holders.

### SUMMARY

One aspect of the present disclosure relates to a fiber optic splice configuration in which a splice protection sleeve is stored in-line with a fiber optic cable. The splice storage location includes structure for providing strain relief to the splice.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is an assembled view of a fiber optic cable including an in-line splice location having features that are examples of inventive aspects in accordance with the principles of the present disclosure; and

FIG. 2 is an exploded view of the fiber optic cable of FIG. 1.

### DETAILED DESCRIPTION

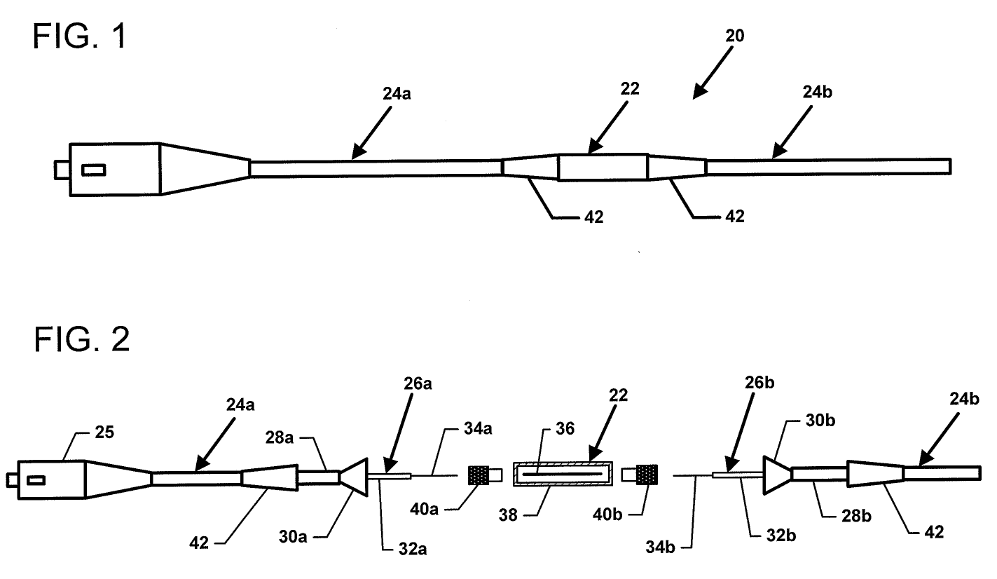

FIGS. 1 and 2 depict a fiber optic cable 20 having an in-line splice location 22 including features that are examples of inventive aspects in accordance with the principles of the present disclosure. Generally, the fiber optic cable 20 includes first and second segments 24a, 24b that are mechanically and optically coupled at the in-line splice location 22. The segments 24a, 24b include optical fibers 26a, 26b that are spliced at the in-line splice location 22 to provide an optical coupling between the fibers 26a, 26b. In one embodiment, the optical fibers 26a, 26b can each include a core defining an outer diameter of about 10 microns, a cladding layer covering the core and defining an outer diameter of about 125 microns, one or more protective coatings that cover the cladding and define an outer diameter of about 250 microns, and a buffer layer that covers the coating layers and defines an outer diameter of about 900 microns.

The first and second segments 24a, 24b also can include outer jackets 28a, 28b that cover the buffer layers, and reinforcing/strength layers 30a, 30b (e.g., layers of reinforcing material, such as aramid yarn (i.e., KEVLAR®), steel, epoxy-reinforced glass roving, or other materials positioned between the jackets 28a, 28b and the buffer layers). In one embodiment, the outer jacket 28a, 28b can each have an outer diameter of about 2 to 3 millimeters. As shown at FIGS. 1 and 2, one end of the first segment 24a is connectorized with a fiber optic connector 25, such as a standard SC connector.

The optical fibers 26a, 26b are preferably fusion spliced at the in-line splice location 22. As shown at FIG. 2, buffer layers 32a, 32b have been stripped from the ends of the optical fibers 26a, 26b to expose coated end portions 34a, 34b of the optical fibers 26a, 26b. In one embodiment, the coated end portions 34a, 34b are fused together and protected within a splice protection sleeve 36. In other embodiments, the coatings can be stripped as well prior to splicing the end portions together. In one embodiment, the splice protection sleeve 36 can include a polymeric tube that is reinforced with a reinforcing member such as a stainless steel layer. The splice protection sleeve 36 is mounted within an outer tube 38. Preferably, the splice protection sleeve 36 is free to move or float linearly within the outer tube 38. In one embodiment, the outer tube 38 can have a polymeric construction. However, it will be appreciated that other materials could be used as well.

Still referring to FIG. 2, strength layer attachment members 40a, 40b are mounted at opposite ends of the outer tube 38. In certain embodiments, the strength layer attachment members 40a, 40b can be glued to the ends of the outer tube 38, press fit within the ends of the outer tube 38, or otherwise mechanically secured to the ends of the outer tube 38. As shown in FIG. 2, the strength layer attachment members 40a, 40b have a textured (e.g., knurled) outer surface that facilitates securing the strength layers 30a, 30b of the segments 24a, 24b to opposite ends of the outer tube 38. In one embodiment, the reinforcing layers 30a, 30b (e.g., KEVLAR® layers) can be crimped, glued, or otherwise secured to their respective strength layer attachment members 40a, 40b.

When the fiber optic cable 20 is assembled, the in-line splice location 22 is positioned in-line with the first and second segments 24a, 24b. In this way, the splice protection sleeve 36 is stored and protected within the cable itself. By attaching the strength layers 30a to the strength layer attachment member 40a and the strength layer 30b to the strength layer attachment location 40b, strain is prevented from being transferred to the splice through the cable. For example, if a field technician pulls on the connectorized end of the segment 24a, strain is transferred from the strength layer 30a through the tube 38 to the strength layer 30b. In this way, the strength layer attachment locations 40a, 40b allow the tube 38 to function as a mechanical shunt that prevents strain from being transferred to the splice within the splice sleeve 36. Boots 42 can be provided at the ends of the in-line splice location 22 (e.g., over the strength layer attachment locations 40a, 40b) to provide enhanced bend protection.

From the foregoing detailed description, it will be evident that modifications and variations can be made in the devices of the disclosure without departing from the spirit or scope of the invention.

What is claimed is:

1. A fiber optic cable comprising:
first and second fiber optic cables segments that are joined at an in-line splice location at which a fiber optic splice is located, the in-line splice location including means for preventing strain from being transferred to the fiber optic splice.

2. The fiber optic cable of claim 1, further comprising boots arranged at opposite ends of the in-line splice location to provide enhanced bend protection to the fiber optic splice.

3. A fiber optic cable comprising:
a first cable segment including a first optical fiber, a first buffer layer, a first strength layer, and a first outer jacket, the first optical fiber having a first end portion;
a second cable segment including a second optical fiber, a second buffer layer, a second strength layer, and a second outer jacket, the second optical fiber having a second end portion optically coupled to the first end portion of the first optical fiber by an optical splice;
a splice protection sleeve arranged about the optical splice;
an outer tube coupled to the first strength layer of the first cable segment and to the second strength layer of the second cable segment, the outer tube being configured to enable the splice protection sleeve and optical splice to move within the outer tube;
whereby the outer tube functions as a mechanical shunt that inhibits strain on the cable segments from being transferred to the optical splice within the splice sleeve

4. The fiber optic cable of claim 3, wherein any strain applied to one of the first and second cable segments is transferred to the other of the first and second cable segment through the outer tube.

5. The fiber optic cable of claim 3, wherein the outer tube is positioned in-line with the first and second cable segments.

6. The fiber optic cable of claim 3, wherein the outer tube is configured to enable the splice protection sleeve to float linearly within the outer tube.

7. The fiber optic cable of claim 3, further comprising strength layer attachment members mounted at opposite ends of the outer tube to facilitate coupling the first and second strength layers to the outer tube.

8. The fiber optic cable of claim 7, wherein the strength layer attachment members are glued to the ends of the outer tube.

9. The fiber optic cable of claim 7, wherein the strength layer attachment members are press fit to the ends of the outer tube.

10. The fiber optic cable of claim 7, wherein the strength layer attachment members have a textured outer surface that facilitates securing the first and second strength layers to the ends of the outer tube.

11. The fiber optic cable of claim 10, wherein the first and second strength layers are crimped to the outer surfaces of the strength layer attachment members.

12. The fiber optic cable of claim 10, wherein the first and second strength layers are glued to the outer surfaces of the strength layer attachment members.

13. The fiber optic cable of claim 7, further comprising boots arranged about the strength layer attachment members at the ends of the outer tube to provide enhanced bend protection.

14. The fiber optic cable of claim 3, wherein the first and second strength layers include aramid yarn.

15. The fiber optic cable of claim 3, wherein the outer tube includes polymeric construction.

16. The fiber optic cable of claim 3, wherein one end of the first segment is connectorized with a fiber optic connector.

17. The fiber optic cable of claim 3, wherein the splice protection sleeve includes a polymeric tube that is reinforced with a reinforcing member.

18. A method of manufacturing a telecommunications cable comprising:
providing first and second segments of telecommunications cable, each segment including an optical fiber, a buffer layer, a strength layer, and an outer jacket;
stripping the outer jacket, the strength layer, and the buffer layer from a first portion of each telecommunications cable segment to expose coated end portions of the optical fibers;
fusing together the coated end portions of the optical fibers to form an optical splice;
arranging the optical splice within a splice protection sleeve;
mounting the splice protection sleeve within an outer tube, wherein the splice protection sleeve is free to move linearly within the outer tube;
mounting first and second strength layer attachment members at opposite ends of the outer tube; and
attaching the strength layer of the first cable segment to the first strength layer attachment member and attaching the strength layer of the second cable segment to the second strength layer attachment member.

19. The method of claim 18, wherein attaching the strength layer of the cable segments to the strength layer attachment members comprises crimping the strength layer of the first cable segment to the first strength layer attachment member and crimping the strength layer of the second cable segment to the second strength layer attachment member.

20. The method of claim 18, wherein mounting first and second strength layer attachment members at opposite ends of the outer tube comprises gluing the first and second strength layer attachment members to opposite ends of the outer tube.
